(19) United States
(12) Patent Application Publication
(10) Pub. No.: US 2010/0262442 A1
(43) Pub. Date: Oct. 14, 2010

(54) System and method of projecting aircraft maintenance costs

(75) Inventor: Ronald Wingenter, San Antonio, TX (US)

Correspondence Address: QUARLES & BRADY LLP, 411 E. WISCONSIN AVENUE, SUITE 2040, MILWAUKEE, WI, 53202-4497, US

(73) Assignee: Standard Aero, Inc., San Antonio, TX (US)

(21) Appl. No.: 11/490,363

(22) Filed: Jul. 20, 2006

(51) Int. Cl. G06Q 10/00

(52) U.S. Cl. 705/7

(57) ABSTRACT

A method of projecting aircraft maintenance costs is disclosed and includes generating a plurality of reliability models associated with a plurality of aircraft mechanical systems. The method also includes performing a plurality of simulations, where each simulation is related to operating one of the plurality of aircraft mechanical systems over a period of time and each simulation based on one of the plurality of reliability models. The method also includes projecting a maintenance cost of each of the plurality of aircraft mechanical systems over the period of time based on each simulation. The method also includes determining a total maintenance cost of the plurality of aircraft mechanical systems over the period of time based on the maintenance cost of each of the plurality of aircraft mechanical systems over the period of time.

### FIELD OF THE DISCLOSURE

The present disclosure is generally relates to systems and methods of projecting aircraft maintenance costs.

### BACKGROUND

Modern mechanical systems include many complex modules that are difficult to repair and otherwise maintain. Various types of mechanical systems, including engines, process control systems, and the like, include many discrete components that can be difficult to evaluate and repair. These complexities are particularly applicable to aircraft engines, such as those on modern commercial and military aircraft. Costs associated with repairs and other maintenance of engines in a fleet of these aircraft can be high. Nonetheless, failure to maintain engines may lead to loss of life and loss of expensive aircraft.

In order to mitigate repair costs and downtime of aircraft in a fleet, airlines and military personnel have attempted to estimate repair costs and other maintenance costs associated with operating aircraft engines. Commercial airlines and military units have begun to utilize statistical reliability analysis techniques to plan and to budget for maintenance of equipment, to predict costs associated with product warranties, and to make decisions about maintenance of a particular device. Nonetheless, these estimations typically do not allow fleet operators to adjust or evaluate results based on their determinations of optimal work scopes, optimal costs, or optimal time in service for engines or engine parts. Moreover, such estimations often do not allow long-term estimations of costs based on user-defined parameters. Hence, there is a need for an improved system and method of projecting aircraft maintenance costs.

### BRIEF DESCRIPTION OF THE DRAWINGS

FIG. 1 is a block diagram of a particular illustrative embodiment of a system to project aircraft maintenance costs;

FIG. 2 is a block diagram of a second particular illustrative embodiment of a system to project aircraft maintenance costs;

FIG. 3 is a block diagram of a third particular illustrative embodiment of a system to project aircraft maintenance costs;

FIG. 4 is a block diagram of a fourth particular illustrative embodiment of a system to project aircraft maintenance costs;

FIG. 5 is a flow diagram of a particular illustrative embodiment of a method of projecting aircraft maintenance costs;

FIG. 6 is a flow diagram of a second particular illustrative embodiment of a method of projecting aircraft maintenance costs; and

FIG. 7 is a block diagram of a fifth particular illustrative embodiment of a system to project aircraft maintenance costs.

### DETAILED DESCRIPTION OF THE DRAWINGS

A system is disclosed that includes a processor and a storage device accessible to the processor. The storage device includes a reliability engine executable by the processor to generate a plurality of reliability models associated with a plurality of aircraft mechanical systems. Further, the storage device includes a simulation engine executable by the processor to perform a plurality of simulations, where each simulation is related to operating one of the plurality of aircraft mechanical systems over a period of time and each simulation based on one of the plurality of reliability models. The storage device also includes a cost modeling tool executable by the processor to project a maintenance cost of each of the plurality of aircraft mechanical systems over the period of time based on each simulation. The cost modeling tool is executable by the processor to determine a total maintenance cost of the plurality of aircraft mechanical systems over the period of time based on the maintenance cost of each of the plurality of aircraft mechanical systems over the period of time.

In another embodiment, a method of projecting aircraft maintenance costs is disclosed and includes generating a plurality of reliability models associated with a plurality of aircraft mechanical systems. The method also includes performing a plurality of simulations, where each simulation is related to operating one of the plurality of aircraft mechanical systems over a period of time and each simulation based on one of the plurality of reliability models. The method also includes projecting a maintenance cost of each of the plurality of aircraft mechanical systems over the period of time based on each simulation. The method also includes determining a total maintenance cost of the plurality of aircraft mechanical systems over the period of time based on the maintenance cost of each of the plurality of aircraft mechanical systems over the period of time.

In another embodiment, a computer program embedded within a computer-readable medium is disclosed and includes instructions to generate a plurality of reliability models associated with a plurality of aircraft mechanical systems. The computer program also includes instructions to perform a plurality of simulations, where each simulation is related to operating one of the plurality of aircraft mechanical systems over a period of time and each simulation based on one of the plurality of reliability models. The computer program also includes instructions to project a maintenance cost of each of the plurality of aircraft mechanical systems over the period of time based on each simulation. The computer program also includes instructions to determine a total maintenance cost of the plurality of aircraft mechanical systems over the period of time based on the maintenance cost of each of the plurality of aircraft mechanical systems over the period of time.

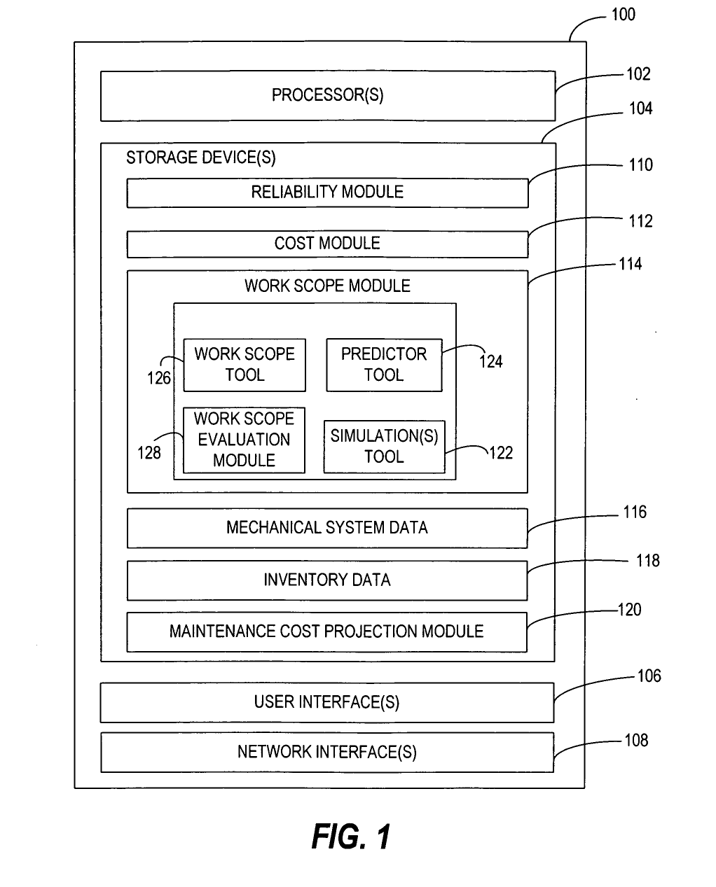

Referring to FIG. 1, a block diagram of a particular illustrative embodiment of a system 100 to project maintenance costs of an aircraft fleet is disclosed. While the system 100 is shown as a single integrated unit, it may be implemented such that one or more of its components reside in separate computing or other electronic devices. The system 100 may include a processor 102 and one or more storage devices 104 accessible to the processor 102. Further, the system 100 can include one or more user interfaces 106 and one or more network interfaces 108. In a particular embodiment, the system 100 can include a single storage device 104. In another particular embodiment, the system 100 can include multiple storage devices having various stored elements distributed among the storage devices. In an illustrative embodiment, the storage device 104 can include a hard disk drive, floppy drive, CD-ROM, CD-R, CD-RW, DVD, RAM, flash memory, or any combination thereof. The storage device 104 may also include storage area networks and other types of distributed memories.

In a particular embodiment, the storage device 104 can be configured to store software and computer-implemented instructions. The storage device 104 can provide instructions and data to the processor 102 to select work scopes for mechanical systems, to model costs of such work scopes, to project maintenance costs of individual aircraft over a period of time, to project maintenance costs of a plurality of aircraft over a period of time, or any combination thereof. For example, the storage device 104 can include a reliability module 110 executable by the processor 102 to model the reliability of an aircraft engine or other mechanical system, to model the reliability of one or more particular components of an aircraft engine or other mechanical system, or any combination thereof. In an illustrative embodiment, the reliability module 110 can model reliability based on historical data related to failure or performance of a particular part, component or module of a mechanical system, manufacturer test data relating to reliability of various components over time, life-limited parts data, and other data.

In a particular embodiment, the storage device 104 can include a cost module 112 executable by the processor 102 to model the cost of operating an aircraft engine or other mechanical system, one or more particular components of an aircraft engine or other mechanical system, or any combination thereof. In an illustrative embodiment, the cost module 112 can include data related to the costs associated with repair and other maintenance events, such as costs of various replacement parts, service-related costs, costs associated with being out of service, and historical data derived from performance of actual service related to similar work scopes.

In a particular embodiment, the storage device 104 can include a work scope module 114 executable by the processor 102 to recommend one or more work scopes to repair or otherwise maintain an aircraft engine, other mechanical system, or one or more engine or system components; to evaluate one or more work scopes to repair or otherwise maintain an aircraft engine, other mechanical system, or one or more engine or system components; or any combination thereof. In an illustrative embodiment, the work scope module 114 can include a simulation tool 122 to simulate an operating period or life of an aircraft engine, other mechanical system, or one or more engine or system components. For example, the simulation tool 122 can be executable by the processor 102 to perform Monte Carlo simulations and other types of statistical simulations of a mechanical system according to reliability models produced via the reliability module 110.

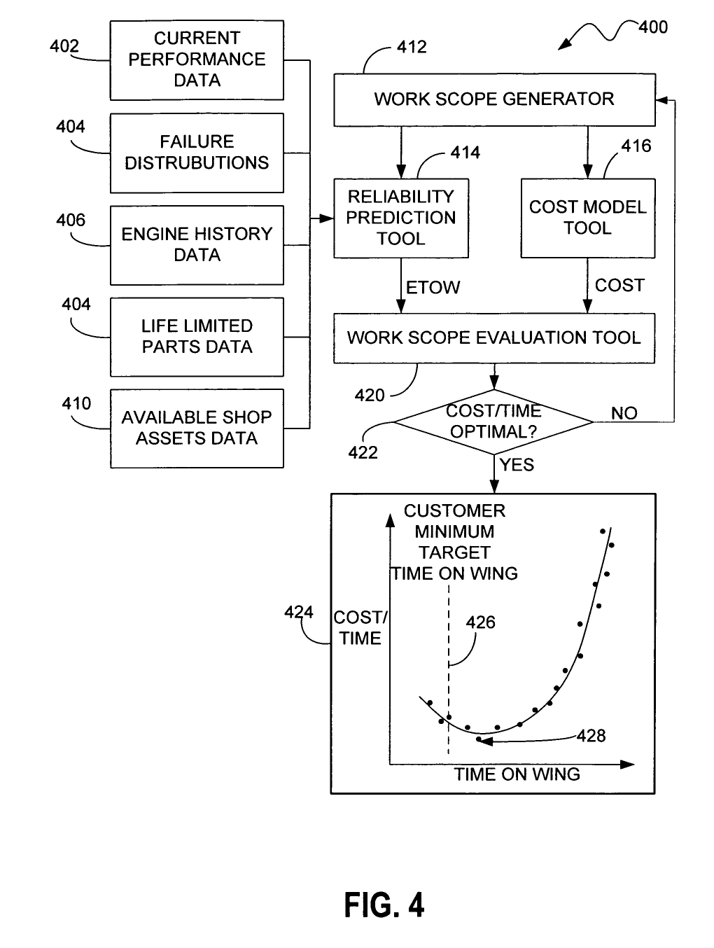

In a particular embodiment, the work scope module 114 can include a predictor tool 124. The predictor tool 124 can be executable by the processor 102 to generate predictions relating to operation of an engine or other mechanical system using reliability models produced by the reliability module 110, simulation results from the simulation tool 122, and other information related to the mechanical system. In an illustrative embodiment, the predictor tool 124 can receive a work scope and estimate an operating time for the mechanical system if the particular work scope is executed. For example, the predictor tool 124 can generate an “estimated time on wing” (ETOW) for an aircraft engine or component. Further, the predictor tool 124 can generate a cost estimate based on the cost module 112 for a given work scope. In addition, the predictor tool 124 can generate a cost performance parameter, such as a function of the estimated operating time and the cost estimate for each work scope. An example of a cost performance parameter is illustrated in FIG. 4.

In a particular embodiment, the work scope module 114 can include a work scope tool 126. The work scope tool 126 can be executable by the processor 102 to generate one or more work scopes to repair a failed engine or other mechanical system, to repair a failed engine or system component, to perform another maintenance task, or any combination thereof. In a particular embodiment, the work scope tool 126 can be executable by the processor 102 to generate one or more work scopes based on threshold or desired operating times, costs, or any combination thereof. For example, the work scope module 114 can include a work scope evaluation module 128 that is executable by the processor 102 to determine one or more work scopes that have an estimated operating time, an estimated cost, cost performance parameter, or any combination thereof, that is equal to, lower than, or greater than a threshold figure. In an illustrative embodiment, the work scope evaluation module 128 can be executable by the processor 102 to determine a work scope having a particular operation time that is greater than a pre-determined threshold, a cost per unit operation time that is lower than a threshold, a cost per unit operation time, or any combination thereof.

The system 100 can include mechanical system data 116, such as data associated with current performance of the mechanical system, data associated with a history of various parts within the mechanical system, and the like. Further, the system 100 can include inventory data 118 such as a list of available shop assets, parts, components and modules for use in the mechanical system. The work scope module 114 may also include information related to the mechanical system data 116 to determine additional tasks to add to the primary work scope, and may utilize the inventory data 118 to estimate costs, both in terms of the cost of obtaining a component and in terms of the lost opportunity cost in terms of the time the engine is out of service.

The user interfaces 106 may include a software interface, such as a graphical user interface for human interaction. Additionally, the user interfaces 106 may include an input interface for coupling to an input device, such as a touch screen, a keyboard, a mouse, a pen device, and the like. The user interfaces 106 may also include a display interface, such as a monitor. For example, a user may utilize the user interfaces 106 to input data associated with the mechanical system for storage in the mechanical system data 116 of the storage devices 104.

The network interfaces 108 may be operable by the processor 102 to access remote computer systems via a communications network, such as a wireless network, a wired communications networks, or both wired and wireless networks. Such communications networks may include Ethernet networks and networks conforming to Wi-Fi, Bluetooth®, and Wi-Max standards, for example. In one particular embodiment, the network interfaces 108 may be used to acquire additional data or model parameters associated with a specific mechanical system, or to communicate results to remote systems.

In an illustrative embodiment, the system 100 can provide a user interface to receive identifications of one or more repair tasks, failed components, other maintenance tasks, or any combination thereof, related to a mechanical system. The processor 102 can access the reliability module 110, the cost module 112, the predictor tool 124 of the work scope module 114, the mechanical system data 116, the inventory data 118, or any combination thereof to generate one or more work scopes related to a repair or other maintenance task. The predictor tool 124 can generate an estimated operating time of the mechanical system, a cost of performing the work scope, and a cost performance parameter based on each work scope, and the work scope evaluation module 128 can determine whether each work scope provides an operating time that is greater than a threshold. Further, the work scope evaluation module 128 can determine a least costly work scope that meets or exceeds the operating time threshold, work scopes whose cost per unit of operating time are equal to or less than a threshold cost per unit of operating time, or any combination thereof. Where no work scope generated by the work scope tool 126 satisfies cost or operating time criteria, the work scope tool 126 can be executable by the processor 102 to generate one or more additional work scopes.

In a particular embodiment, the system 100 can include a maintenance cost projection module 120 that is executable by the processor 102 to project repair and other maintenance costs for individual aircraft or a plurality of aircraft, such as a fleet, over a period of time. For example, the system 100 can generate a failure queue that identifies each aircraft in a fleet. The failure queue can indicate projected work scopes over a period of time for repairs and other maintenance tasks related to engines, other mechanical systems, engine or system components, or any combination thereof, of each such aircraft. The work scopes can be projected based on reliability models, simulations, or any combination thereof. The work scopes can be evaluated to determine that they will meet threshold criteria for predicted operating time, predicted costs, or any combination thereof. Cost models can be used to determine projected costs for each work scope indicated in the failure queue, and a total cost can be projected to operate the fleet over the period of time. Additionally, the aircraft maintenance projection module 120 can determine that one or more aircraft within a fleet should be replaced when no work scope for an engine, system or component of the aircraft satisfies operating time thresholds, cost thresholds, or any combination thereof.

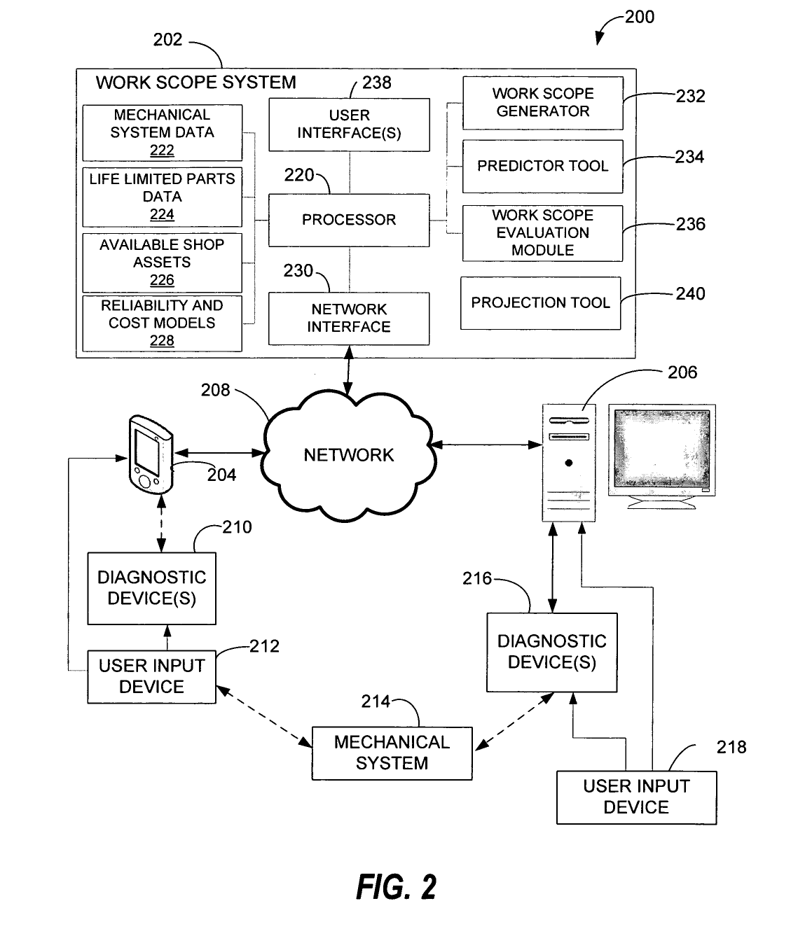

FIG. 2 is a block diagram of a second particular illustrative embodiment of a system 200 to project maintenance costs of a mechanical system of an aircraft, such as an aircraft engine. The system 200 can include a work scope system 202, a handheld device 204 and a computing system 206 that are communicatively coupled via a network 208. The handheld device 204 may be coupled to one or more diagnostic devices 210 and to a user input device 212 to receive inputs related to repairs or other maintenance required by a mechanical system 214, such as an aircraft engine or another type of mechanical system. The computing system 206 can be coupled to one or more diagnostic devices 216 and to a user input device 218 to receive inputs related to repairs or other maintenance required by the mechanical system 214.

The work scope system 202 includes a processor 220 and data accessible to the processor 220, such as mechanical system data 222, life-limited parts data 224, available shop assets 226, and reliability and cost models 228. The work scope system 202 can also include a network interface 230 adapted to communicatively couple the work scope system 202 to the network 208. Additionally, the work scope system 202 can include a work scope generator 232, a predictor tool 234, a work scope evaluation module 236, and one or more user interfaces 238.

In an illustrative, non-limiting embodiment, the work scope system 202 can receive diagnostic information associated with the mechanical system 214 from the network 208 via the network interface 230, from the one or more user interfaces 238, or from any combination thereof. For example, diagnostic information associated with the mechanical system 214 can be input by a user via user-input device 212 to the handheld device 204, which transmits the information to the work scope system 202 via the network 208. In a particular embodiment, a diagnostic device 210 may be coupled to the mechanical system 214 to derive performance information and other data from the mechanical system 214 and to provide the information to the handheld device 204.

In an alternative embodiment, the computing system 206 may receive diagnostic information related to the mechanical system 214 from the user-input device 218, from one or more diagnostic devices 216 coupled to the mechanical system 214, or any combination thereof. The computing system 206 may transmit the diagnostic information into the work scope system 202 via the network 208.

In a particular embodiment, the work scope system 202 can process diagnostic information to generate one or more work scopes related to the mechanical system 214. For instance, the processor 220 can access the work scope generator 232, mechanical system data 222, the life-limited parts data 224, the available shop assets 226, the reliability and cost models 228, or any combination thereof, to generate one or more work scopes associated with repair or other maintenance of the mechanical system 214. Further, the processor 220 can access the predictor tool 234, mechanical system data 222, the life-limited parts data 224, the available shop assets 226, the reliability and cost models 228, or any combination thereof, to generate an estimated operating time and an associated cost per unit operating time resulting from the completion of each work scope for the mechanical system.

Additionally, the processor 220 can access the work scope evaluation module 236 to determine whether the estimated operating time and cost per unit operating time satisfy thresholds set by a user, operator, governmental agency, manufacturer, or any combination thereof. Where such thresholds are not satisfied, the processor 220 can access the work scope generator 232, mechanical system data 222, the life-limited parts data 224, the available shop assets 226, the reliability and cost models 228, or any combination thereof, to generate one or more additional work scopes. Where such thresholds are satisfied, a desired work scope can be selected based on a number of parameters including a cost of the maintenance, an operating time, a function of cost and operating time, or any combination thereof.

In a particular embodiment, the processor 220 can access a projection tool 240 to project maintenance costs for individual aircraft or a plurality of aircraft, such as a fleet, over a period of time. For example, the projection tool 240 can be executable by the processor 220 to generate a failure queue that identifies each aircraft in a fleet. The failure queue can indicate projected work scopes over a period of time for repairs and other maintenance tasks related to engines, other mechanical systems, engine or system components, or any combination thereof, of each such aircraft. The work scopes can be projected based on the mechanical system data 222, the life-limited parts data 224, the available shop assets 226, the reliability and cost models 228, or any combination thereof.

The work scopes can be evaluated to determine that they will meet threshold criteria for predicted operating time, predicted costs, or any combination thereof. Further, cost models can be used to determine projected costs for each work scope indicated in the failure queue, and a total cost can be projected to maintain the fleet over the period of time. Additionally, the aircraft maintenance projection module 240 can be executable by the processor 220 to determine that one or more aircraft within a fleet should be replaced when no work scope for an engine, system or component of the aircraft satisfies operating time thresholds, cost thresholds, or any combination thereof.

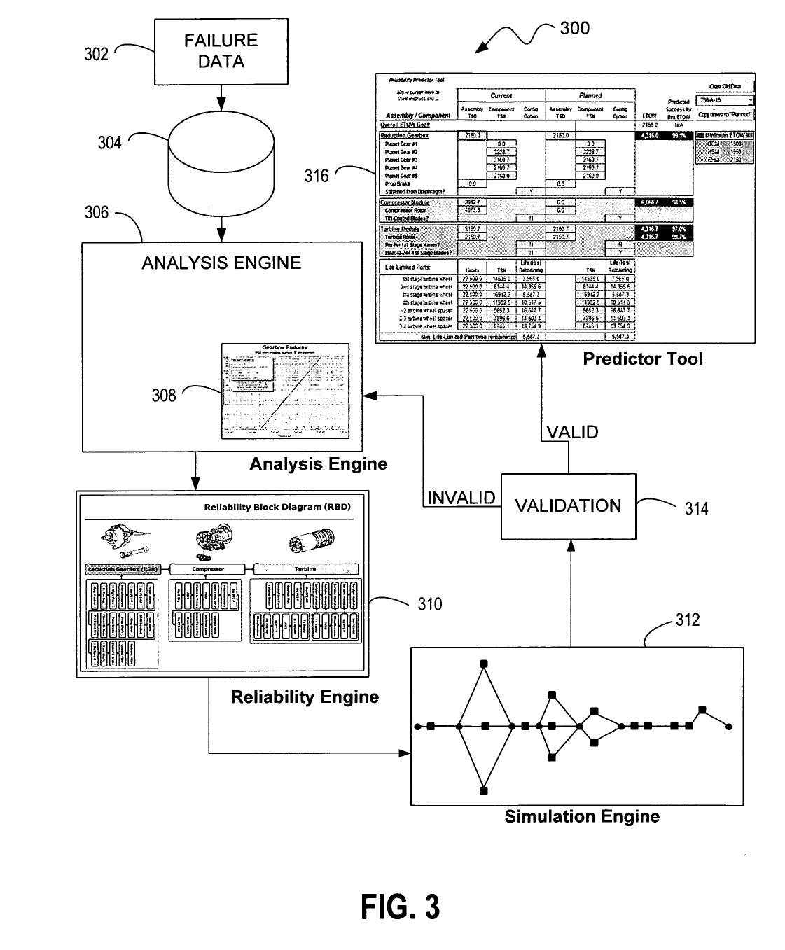

FIG. 3 is a block diagram of a third particular illustrative embodiment of a system 300 to project aircraft maintenance costs. In a particular embodiment, the system 300 is suitable to develop a predictor tool 316 to project operating times, repair and other maintenance costs per unit operating time, or any combination thereof. The system 300 includes failure data 302 that may be collected and stored at a data store 304. The system 300 also includes an analysis engine 306, a reliability modeling engine 310, a simulation engine 312, a validation tool 314, and the predictor tool 316.

In a particular embodiment, data related to failure or projected failure of components of a mechanical system, such as an aircraft engine, is collected and stored at the data store 304. An analysis engine 306 can access the data store 304 to retrieve the collected data 302 and to produce a failure model 308 associated with each component of the mechanical system. The failure model 308 may be presented in a graphical user interface (GUI) of a system such as the computing system 100 illustrated in FIG. 1 or the work scope system 202 illustrated in FIG. 2. In an illustrative embodiment, a user can adjust or modify the failure model 308 or the parameters on which the failure model 308 is based via the GUI. For example, an analysis based on failure data 302 that is collected on parts may not include failure data for life-limited parts, since such parts are required to be removed prior to the expiration of the life-limit. Accordingly, a user can access the failure model 308 via the GUI to adjust the life term of a life-limited component within the analysis data.

A reliability engine 310 can model the reliability of each component of the mechanical system based on the failure data 302, the failure model 308 from the analysis engine 306, or any combination thereof. The simulation engine 312 can simulate operation of the mechanical system, one or more components of the mechanical system, or any combination thereof, based on the reliability models. In a particular embodiment, the simulation engine 312 can generate an estimated operating time for the particular mechanical system after repair or other maintenance is performed on one or more parts of the mechanical system. In an illustrative embodiment, the simulation engine 312 can perform Monte Carlo simulations to generate an estimated time on wing (ETOW) related to the mechanical system.

In a particular embodiment, a validation tool 314 can compare the data 302 to the simulations conducted by the simulation engine 312 and can determine whether the reliability model and resulting simulation results are valid. If the validation tool 314 determines that the reliability model and resulting simulation results are invalid, the analysis engine 306 can re-analyze the data 302 and one or more other reliability models and simulations can be generated and validated. If the validation tool 314 determines that the reliability model and resulting simulation results are valid, the validation tool 314 provides the valid reliability model to the predictor tool 316. The predictor tool 316 can apply the reliability model to work scopes related to repair and other maintenance of the mechanical system to generate estimates of the operating time and maintenance costs of the given mechanical system.

In an illustrative embodiment, the operating time, maintenance costs, or any combination thereof, related to a work scope can be compared to thresholds set by a user, manufacturer, government agency, other party, or any combination thereof, to determine whether the work scope is optimal or otherwise meets defined criteria. Further, costs associated with work scopes that meet defined criteria can be determined for each aircraft engine or other mechanical system in a fleet of aircraft over a period of time, and a total maintenance cost related to the fleet can be projected for the period of time.

FIG. 4 is a block diagram of a fourth particular illustrative embodiment of a system 400 to project aircraft maintenance costs. In a particular embodiment, the system 400 can generate work scopes based on reliability models related to one or more components of a mechanical system, such as an aircraft engine. The system 400 includes data such as current performance data 402, failure distribution data 404, engine history data 406, life-limited parts data 408, and available shop assets 410. The system 400 also includes a work scope generator 412, a reliability prediction tool 414, a cost model tool 416, a work scope evaluation tool 420, and an output 424.

In an illustrative embodiment, the work scope generator 412 can generate one or more work scopes related to failure or maintenance associated with a mechanical system or one or more components thereof. The work scope generator 412 can provide the work scope(s) to the reliability prediction tool 414. The reliability prediction tool 414 can utilize data to generate an estimated operating time for the mechanical system based on each of the work scopes of the set of work scopes. For example, the reliability prediction tool 414 can model the reliability of the mechanical system after completion of a work scope, based on current performance data 402 related to the mechanical system; failure distributions 404 related to the mechanical system, such as operation level (O-level) failure distributions; the performance history 406 of the mechanical system; life-limited parts data 408; and the available shop assets data 410.

In an illustrative embodiment, the reliability prediction tool 414 can estimate an out-of-service time for the mechanical system, at least partially based on the availability of particular parts for a given work scope. For example, if a particular part is not available in the inventory of the available shop assets data 410, then additional down time may be required to acquire the part and to complete a particular maintenance task. Therefore, performance of that particular work scope that includes the task for which the part is not currently available may further reduce an estimated operating time for the mechanical system.

Further, the work scope generator 412 can provide the generated work scope(s) to the cost model tool 416. The cost model tool 416 can estimate costs associated with each work scope. In an illustrative embodiment, the cost model tool 416 can estimate such costs based on costs associated with components of the mechanical system; labor costs associated with repairs and other maintenance of the mechanical system; out-of-service costs associated with downtime of an aircraft associated with the mechanical system; other costs; or any combination thereof.

In a particular embodiment, the estimated costs and operating times that are associated with the work scope(s) are provided to the work scope evaluation tool 420. The work scope evaluation tool 420 determines whether the work scope(s) meet threshold criteria. For example, the work scope evaluation tool 420 can compare costs and estimated operating time for individual work scopes. The cost per unit time relative to the operating time (time on wing) may be provided via an output 424, such as a graphical user interface. The operation of the work scope generator 412, the reliability prediction tool 414, the cost model tool 416, and the work scope of the evaluation tool 420 may be iterative such that the system 400 processes each work scope of the set of work scopes until a cost versus time parameter of the particular work scope appears to be desired or to meet threshold criteria at decision node 422.

In one particular embodiment, the work scope generator 412 can generate one work scope at a time for processing by the reliability prediction tool 414 and the cost model tool 416 and for evaluation by the work scope evaluation tool 420. In another particular embodiment, the work scope generator 412 can generate a set of work scopes based on a primary work scope, and the set of work scopes may be processed in parallel or in series by the reliability prediction tool 414 and the cost model tool 416 and by the work scope evaluation tool 420.

In the embodiment illustrated in FIG. 4, the output 424 can represent various work scopes as dots on a graph. The threshold at 426 is defined by a user, for example, as a minimum target time on wing, such that the operating time of the mechanical system is expected to exceed the minimum target time before the work scope evaluation tool 420 would select the work scope as a desired work scope. A desired work scope indicated at 428 is a work scope that exceeds the minimum target threshold 426 and that has a lowest cost per unit time relative to other possible work scopes that exceed the threshold 426. In one particular embodiment, the output 424 can plot a curve based on the set of work scopes and their associated estimated operating time and costs per unit operating time.

In a particular embodiment, costs associated with work scopes that meet defined criteria can be determined for each aircraft engine or other mechanical system in a fleet of aircraft over a period of time, and a maintenance cost related to the fleet can be projected for the period of time.

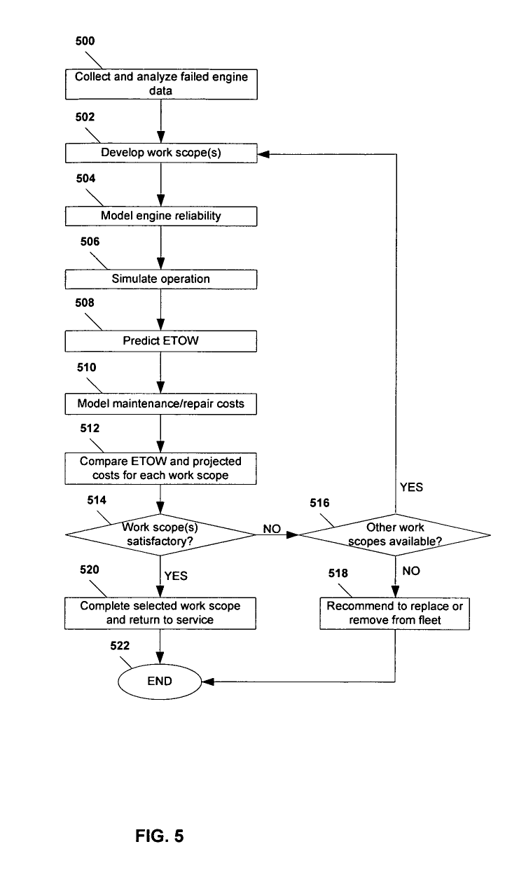

FIG. 5 is a flow diagram of a particular illustrative embodiment of a method of projecting aircraft maintenance costs. At block 500, data related to failure or projected failure of an aircraft engine or other mechanical system is collected and analyzed. For example, an on-wing inspection of an aircraft engine can reveal that a repair cannot be practically or efficiently accomplished with the engine installed and is required to meet operational requirements. In another example, an inspection performed after de-installation of an engine can allow other failures or repair tasks to be identified or projected. Data related to a current or projected failure can be received at a computing system via manual input at a keyboard or other input device; via a diagnostic computing tool; via another device suitable to input data to a computing device; or any combination thereof. Alternatively, the data can be stored at a data store and retrieved by the computing device from the data store. In an illustrative embodiment, a failure model associated with the engine, with one or more components of the engine, or any combination thereof, can be produced and displayed by the computing system after it analyzes the data.

Moving to block 502, one or more work scopes are generated by the computing system based on the failure data. In an illustrative embodiment, a work scope can identify one or more repair tasks, one or more engine components to be repaired or replaced, other information associated with repair or other maintenance of an engine, or any combination thereof. Each work scope can be associated with one or more current repair tasks required for an aircraft engine or mechanical system; with one or more projected repair tasks required for an aircraft engine or mechanical system; or any combination thereof.

Proceeding to block 504, the reliability of each component of the engine can be modeled based on the data received at block 500, the results of analyzing the data, engine history data, current performance data associated with the engine, life-limited parts data, shop assets data, operation level (O-level) failure distributions, or any combination thereof. Continuing to block 506, in a particular embodiment, operation of the aircraft engine or other mechanical system can be simulated based on the reliability model. Advancing to block 508, an estimated operating time for the particular mechanical system after one or more current repair tasks, one or more projected repair tasks, or any combination thereof, are performed according the work scope(s) generated at block 502. In an illustrative embodiment, the simulation engine 312 can perform Monte Carlo simulations to generate an estimate time on wing (ETOW) related to the aircraft engine or mechanical system after performing each work scope.

At block 510, costs related to completing each work scope are modeled. Such costs can be projected based on, for example, availability and expenses of replacements for components of the aircraft engine or mechanical system; labor required to complete each work scope; depot level (D-level) failure distributions; intermediate level (I-level) failure distributions; downtime associated with completing a work scope; other costs; or any combination thereof.

Moving to block 512, operating time and costs associated with each work scope are compared. In an illustrative embodiment, a cost performance parameter can be generated for each work scope and can be represented in a display or other output, such as that illustrated at 424 in FIG. 4. Continuing to decision step 514, the computing system, user, or any combination thereof, determines whether each work scope is optimized or at least satisfies certain criteria. For example, the user, fleet operator, manufacturer, government agency, or any combination thereof, can determine a minimum acceptable ETOW for an engine after a work scope is completed for the engine or one or more components thereof. A desired and selected work scope can be a work scope that meets or exceeds the threshold ETOW while requiring the lowest estimated cost per unit of operating time. Alternatively, the user, fleet operator, or other party can determine a maximum cost per unit of operating time, and any work scope that meets or exceeds the threshold ETOW, while remaining at or below the maximum cost per unit operating time could be considered satisfactory, resulting in a range of selectable work scopes.

In a particular embodiment, if it is determined that the work scope(s) generated at block 502 are not satisfactory, the method can proceed to decision step 516, and it is determined whether any other work scopes can be generated to address the engine or mechanical system failure(s) associated with the particular work scope. If other work scopes can be generated, the method returns to block 502. On the other hand, if no other work scopes are available to correct a failure, the method moves to block 518, and replacement of the engine or removal from the fleet is recommended. The method then terminates at 522.

Returning to decision step 514, if it is determined that the work scope(s) generated at block 502 are satisfactory, the method continues to block 520, and the work scope can be completed and the engine returned to service. If more than one satisfactory work scope is generated at block 502, a work scope can be selected from the range of satisfactory works scopes. The method terminates at 522.

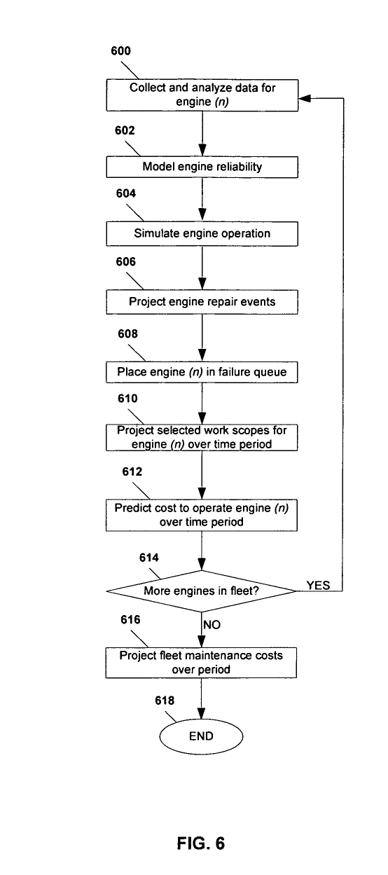

FIG. 6 is a flow diagram of a second particular illustrative embodiment of a method of projecting aircraft maintenance costs. At block 600, data related to an aircraft engine or other mechanical system is collected and analyzed to project the reliability of the engine over a period of time. For example, engine history data, current engine performance data, life-limited engine parts data, shop assets data, operation level (O-level) failure distributions, or any combination thereof, can be collected with respect to the engine. The data can be received at a computing system via manual input at a keyboard or other input device; via a diagnostic computing tool; via another device suitable to input data to a computing device; or any combination thereof. Alternatively, the data can be stored at a data store and retrieved by the computing device from the data store. In an illustrative embodiment, a failure model associated with the engine, with one or more components of the engine, or any combination thereof, can be produced and displayed by the computing system after it analyzes the data.

Moving to block 602, a reliability model is generated for the engine based on the data received at block 600, the results of analyzing the data, or any combination thereof. Continuing to block 604, in a particular embodiment, operation of the aircraft engine can be simulated based on the reliability model. Proceeding to block 606, failures or other repair events can be projected for the engine based on the simulations. Advancing to block 608, in an illustrative embodiment, the engine can be placed in a failure queue that represents a sequence, calendar, or other ordering in which engines or components of engines in a fleet of aircraft are projected to need repair.

Moving to block 610, one or more work scopes can be generated for each repair event projected at block 606. In an illustrative embodiment, a work scope can identify one or more repair tasks, one or more engine components to be repaired or replaced, other information associated with repair or other maintenance of an engine, or any combination thereof. Each work scope can be associated with one or more current repair tasks required for an aircraft engine or mechanical system; with one or more projected repair tasks required for an aircraft engine or mechanical system; or any combination thereof. In a particular embodiment, a desired work scope can be selected from one or more work scopes associated with a repair event, by projecting costs and operating times associated with completing each work scope and determining a work scope that meets or exceeds a threshold operating time with a lowest cost per unit operating time.

Advancing to block 612, a cost to operate the engine over the period of time is estimated. For example, the costs of the selected work scopes associated with each projected repair event for the engine can be summed to yield a total cost to operate the engine over the period of time. In an illustrative embodiment, other costs can be added to this sum, such as cleaning costs, routine inspection costs, and other costs that are required for engine operation but not associated with repair events. In another embodiment, projected costs to operate the engine may include replacement costs, for instance, when no work scope can be generated for a repair event that exceeds an operating time threshold.

Continuing to decision step 614, it is determined whether there are more engines in a fleet of aircraft. If there are additional engines in the fleet, the method returns to block 600, and data is collected and analyzed with respect to another engine in the fleet. Conversely, if there are no additional engines in the fleet, i.e., costs to operate all engines in the fleet have been estimated, the method proceeds to block 616, and maintenance costs for the fleet of aircraft are estimated over the period of time. For example, the estimated costs of operating each engine over the period of time can be summed to yield a total maintenance cost to operate the fleet of aircraft on which the engines are used. This can take into account, for example, engine replacement, multiple engines on individual aircraft in the fleet, costs associated with downtime to complete work scopes associated with repair events, and other factors. The method terminates at 618.

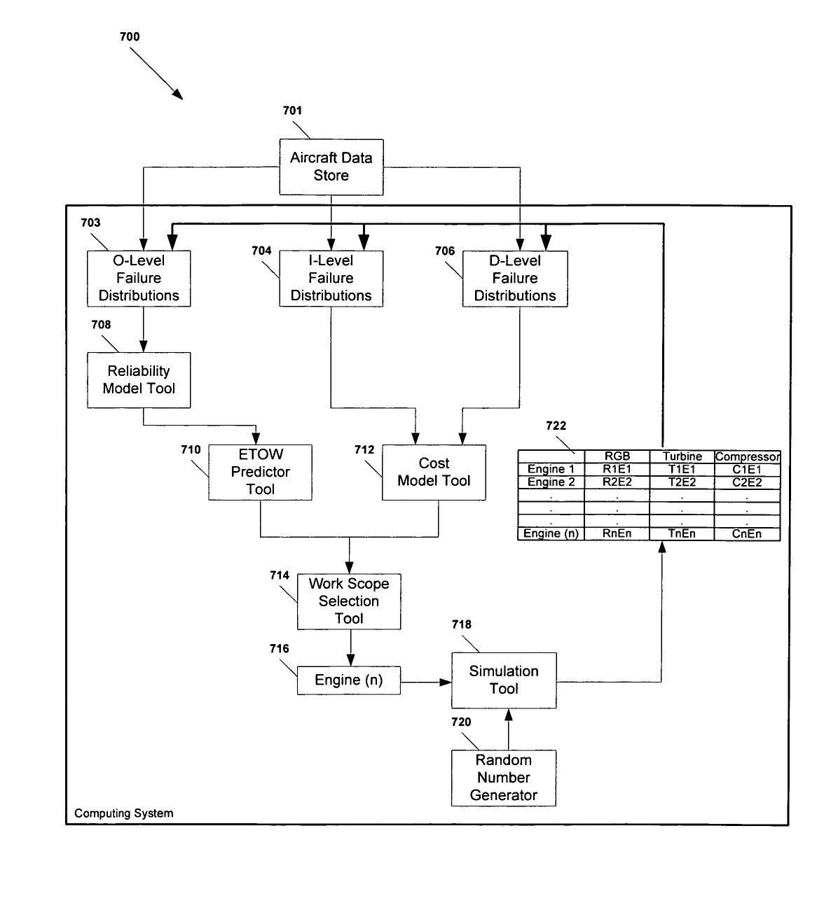

FIG. 7 is a block diagram illustrating a fourth particular embodiment of a system to project aircraft maintenance costs. The system 700 includes an aircraft data store 701 and a computing system 702. The computing system can include a reliability model tool 708 and an estimated time on wing (ETOW) predictor tool 710. Further, the computing system 702 can include a cost model tool 712. In addition, the computing system 702 can include a work scope selection tool 714. Moreover, the computing system 702 can include a simulation tool 718 and a random number generator 720.

In a particular embodiment, data related to one or more aircraft engines or mechanical systems can be stored at the aircraft data store and can be retrieved by the computing system 702 for analysis. For example, the computing system 702 can utilize such data to produce failure models with respect to one or more aircraft engines, such as operation level (O-level) failure distributions 703, intermediate level (I-level) failure distributions 704, depot level (D-level) failure distributions 706, or any combination thereof.

The computing system 702 can generate a reliability model associated with an individual engine based on the aircraft engine data and analysis thereof. In addition, the ETOW predictor tool 710 can predict an estimated operating time, such as an estimated time on wing (ETOW) for the engine over a period of time, based on the reliability model, projected operating conditions, repair or other maintenance events, other data, or any combination thereof. Further, the computing system 702 can use a cost model tool 712 to generate a cost model associated with a repair or other maintenance event for an engine based on aircraft engine data and analysis thereof, as well as fail dates, inspection or shop visit costs, hourly repair costs, such as labor costs, materials costs, and the like.

The reliability model tool 710 and cost model tool 712 can be used by the work scope selection tool 714 to select work scopes for a repair or other maintenance event associated with an aircraft engine. For example, operation of an engine (n) 716 can be simulated via a simulation tool 718, in order to project repair or other maintenance events, such as failure or expiration of life-limited parts. In an illustrative embodiment, the simulation tool 718 can be a Monte Carlo sampling tool that communicates with a random generator 720.

In a particular embodiment, repair events can be projected for the engine (n) 716 via the simulation tool 718. The engine (n) 716 can be placed in a projected failure queue 722 that represents an ordering of projected repair or other maintenance events for aircraft engines, engine components, or any combination thereof, over a period of time. The failure queue 722 can be used in combination with data stored at the aircraft data store 701 to produce failure models, such as the failure distributions 703, 704, 705, for aircraft in a fleet of aircraft. Selected work scopes for each repair event associated with an engine in the failure queue 722 can be generated by the work scope selection tool 714, using results from the reliability model tool, the ETOW predictor tool, the cost model tool, or any combination thereof. Costs associated with each projected repair or other maintenance event represented in the failure queue can be summed, thus indicating at least a portion of a projected cost to operate all engines in a fleet of aircraft.

In a particular embodiment, the steps of the methods described herein can be executed in the order shown by the figures. In alternative embodiments, some steps can be executed simultaneously or in alternative sequences. Additionally, in accordance with various embodiments, the methods described herein may be implemented as one or more software programs running on a computer processor. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

It should also be noted that software that implements the disclosed methods may optionally be stored on a tangible storage medium, such as: a magnetic medium, such as a disk or tape; a magneto-optical or optical medium, such as a disk; or a solid state medium, such as a memory card or other package that houses one or more read-only (non-volatile) memories, random access memories, or other re-writable (volatile) memories. The software may also utilize a signal containing computer instructions. A digital file attachment to e-mail or other self-contained information archive or set of archives is considered a distribution medium equivalent to a tangible storage medium. Accordingly, the disclosure is considered to include a tangible storage medium or distribution medium as listed herein, and other equivalents and successor media, in which the software implementations herein may be stored.

Although the present specification describes components and functions that may be implemented in particular embodiments with reference to particular standards and protocols, the invention is not limited to such standards and protocols. For example, standards for packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments and are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

The above-disclosed subject matter is to be considered illustrative, and not restrictive, and the appended claims are intended to cover all such modifications, enhancements, and other embodiments that fall within the true spirit and scope of the present invention. This disclosure is intended to cover any and all subsequent adaptations or variations of various embodiments. Combinations of the above embodiments, and other embodiments not specifically described herein, will be apparent to those of skill in the art upon reviewing the description. Thus, to the maximum extent allowed by law, the scope of the present invention is to be determined by the broadest permissible interpretation of the following claims and their equivalents, and shall not be restricted or limited by the foregoing detailed description.

1. A method of projecting aircraft maintenance costs, the method comprising:
providing collected data on a storage medium accessible by a computer system, said collected data being associated with a plurality of aircraft mechanical systems;
operating a computer system programmed to perform the steps of:
generating a plurality of reliability models based on said collected data associated with a plurality of aircraft mechanical systems;
performing a plurality of simulations, each simulation related to operating one of the plurality of aircraft mechanical systems over a period of time and each simulation based on one of the plurality of reliability models, at least one simulation of said plurality of simulations being a Monte Carlo simulation generating an estimated time for failure of one of said aircraft mechanical systems;
projecting a maintenance cost of each of the plurality of aircraft mechanical systems over the period of time based on each simulation; and
determining a total maintenance cost of the plurality of aircraft mechanical systems over the period of time based on the maintenance cost of each of the plurality of aircraft mechanical systems over the period of time.

2. The method of claim 1, further comprising:
determining, based on the plurality of simulations, a plurality of maintenance events for the plurality of aircraft mechanical systems during the period of time;
generating a plurality of work scopes to be performed during the period of time, wherein each of the plurality of work scopes is related to one of the plurality of maintenance events; and
wherein the total maintenance cost is based on costs of the plurality of work scopes.

3. The method of claim 2, wherein each of the plurality of work scopes is a work scope selected from a set of possible work scopes related to one of the plurality of maintenance events.

4. The method of claim 3, further comprising:
determining an operating time and a cost resulting from each work scope in the set of possible work scopes;
determining a subset of the set of possible work scopes, wherein the operating time resulting from each work scope in the subset meets or exceeds a user-defined threshold operating time; and
wherein the cost of the selected work scope is less than the cost of each other work scope in the subset.

5. The method of claim 4, further comprising arranging identifications of the plurality of aircraft mechanical systems in a failure queue based on operating times resulting from each selected work scope.

6. The method of claim 2, wherein the plurality of maintenance events includes failure of the mechanical system, repair of the mechanical system, scheduled maintenance of the mechanical system, scheduled replacement of the mechanical system, or any combination thereof.

7. The method of claim 1, wherein each of the reliability models is based on said collected data that includes performance data related to one of the plurality of aircraft mechanical systems, historical data related to one of the plurality of aircraft mechanical systems, failure data collected from one of the plurality of aircraft mechanical systems, life limited parts data related to one of the plurality of aircraft mechanical systems, available shop assets data, operation-level failure distributions related to one of the plurality of aircraft mechanical systems, or any combination thereof.

8. The method of claim 7, wherein at least a portion of the collected data is related to at least one component of one of the plurality of aircraft mechanical systems.

9. The method of claim 8, wherein the at least one component includes a turbine, a compressor, a reduction gearbox, or any combination thereof.

10. A system comprising:
a processor and a storage device accessible to the processor;
wherein the storage device includes a reliability engine executable by the processor to generate a plurality of reliability models associated with a plurality of aircraft mechanical systems;
wherein the storage device includes a simulation engine executable by the processor to perform a plurality of simulations, each simulation related to operating one of the plurality of aircraft mechanical systems over a period of time and each simulation based on one of the plurality of reliability models, at least one simulation of said plurality of simulations being a Monte Carlo simulation generating an estimated time for failure of one of said aircraft mechanical systems;
wherein the storage device includes a cost modeling tool executable by the processor to project a maintenance cost of each of the plurality of aircraft mechanical systems over the period of time based on each simulation; and
wherein the cost modeling tool is executable by the processor to determine a total maintenance cost of the plurality of aircraft mechanical systems over the period of time based on the maintenance cost of each of the plurality of aircraft mechanical systems over the period of time.

11. The system of claim 10, wherein the aircraft mechanical system is an aircraft engine.

12. The system of claim 10, wherein:
the simulation engine is executable by the processor to determine, based on the plurality of simulations, a plurality of maintenance events for the plurality of aircraft mechanical systems during the period of time;
the storage device includes a work scope generator executable by the processor to generate a plurality of work scopes to be performed during the period of time, wherein each of the plurality of work scopes is related to one of the plurality of maintenance events; and
wherein the total maintenance cost is based on costs of the plurality of work scopes.

13. The system of claim 12, wherein at least one of the maintenance events includes failure of a component of the mechanical system, repair of a component of the mechanical system, scheduled maintenance of a component of the mechanical system, scheduled replacement of a component of the mechanical system, or any combination thereof.

14. The system of claim 12, wherein:
the storage device includes a work scope evaluation module to select each of the plurality of work scopes from a set of possible work scopes related to one of the plurality of maintenance events;
the storage device includes a projector tool executable by the processor to determine an operating time resulting from each work scope in the set of possible work scopes;
the cost modeling tool is executable by the processor to determine a cost of each work scope in the set of possible work scopes;
the work scope evaluation tool is executable by the processor to determine a subset of the set of possible work scopes, wherein the operating time resulting from each work scope in the subset meets or exceeds a user-defined threshold operating time; and
wherein the cost of each of the plurality of selected work scopes is less than the cost of each other work scope in its subset.

15. The system of claim 14, wherein the operating time is an estimated time on-wing.

16. The system of claim 10, further comprising a user interface module executable by the processor to receive data collected by a diagnostic device coupled to the aircraft mechanical system.

17. The system of claim 10, further comprising an analysis engine executable by the processor to analyze data related to each of the plurality of aircraft mechanical systems and to generate a plurality of failure models based on the data, wherein each of the plurality of aircraft mechanical systems is associated with at least one of the plurality of failure models.

18. The system of claim 17, wherein each of the plurality of reliability models is based on at least one failure model associated with one of the plurality of aircraft mechanical systems.

19. The system of claim 17, wherein the analysis engine is executable by the processor to:
display at least one of the plurality of failure models via a graphical user interface; and
modify at least one of the plurality of failure models based on commands received from a user.

20. The system of claim 17, wherein the plurality of failure models includes operation-level (0-level) failure distributions, intermediate-level (I-level) failure distributions, depot-level (D-level) failure distributions, or any combination thereof.

21. A computer program stored on a tangible computer-readable storage medium, the computer program comprising:
instructions to generate a plurality of reliability models associated with a plurality of aircraft mechanical systems;
instructions to perform a plurality of simulations, each simulation related to operating one of the plurality of aircraft mechanical systems over a period of time and each simulation based on one of the plurality of reliability models, at least one simulation of said plurality of simulations being a Monte Carlo simulation generating an estimated time for failure of one of said aircraft mechanical systems;
instructions to project a maintenance cost of each of the plurality of aircraft mechanical systems over the period of time based on each simulation; and
instructions to determine a total maintenance cost of the plurality of aircraft mechanical systems over the period of time based on the maintenance cost of each of the plurality of aircraft mechanical systems over the period of time.

22. The computer program of claim 21, further comprising:
instructions to determine, based on the plurality of simulations, a plurality of maintenance events for the plurality of aircraft mechanical systems during the period of time;
instructions to generate a set of possible work scopes for each of the plurality of maintenance events;
instructions to estimate an operating time resulting from each work scope in each set of possible work scopes;
instructions to determine a cost of each work scope in each set of possible work scopes; and
instructions to determine a subset of each set of possible work scopes, wherein the operating time resulting from each work scope in each subset meets or exceeds a user-defined threshold operating time.

23. The computer program of claim 22, further comprising:
instructions to display a graphical output representing operating time and cost for each work scope in a set of possible work scopes; and
instructions to receive a selection of a work scope represented by the graphical output via a user interface.

24. The computer program of claim 22, further comprising instructions to receive the user-defined threshold operating time via a user interface.
